(19) United States
(12) Patent Application Publication
(10) Pub. No.: US 2019/0289675 A1
(43) Pub. Date: Sep. 19, 2019

(54) THREE-LAYERED HEATED BLANKET

(71) Applicant: Perfect Fit Industries LLC, Charlotte, NC (US)

(72) Inventor: Amarinthia BELL, Charlotte, NC (US)

(21) Appl. No.: 16/357,646

(22) Filed: Mar. 19, 2019

Related U.S. Application Data
(60) Provisional application No. 62/644,879, filed on Mar. 19, 2018.

(51) Int. Cl. H05B 3/34; B32B 5/02; B32B 7/09

(52) U.S. Cl. CPC H05B 3/342; B32B 2262/0276; B32B 7/09; B32B 5/022

(57) ABSTRACT

A heated blanket includes a base fabric layer; an inner fabric layer quilted to the base fabric layer in a manner forming a wire channel between the base fabric layer and the inner fabric layer; a heating wire disposed within the wire channel; and a face fabric layer secured to one or more of the base fabric layer or the inner fabric layer. A method comprises of manufacturing a heated blanket includes quilting an inner fabric layer to a base fabric layer in a manner forming a wire channel between the base fabric layer and the inner fabric layer; and threading a heating wire through the wire channel.

### CROSS-REFERENCE TO RELATED APPLICATIONS

This application claims the benefit of priority under 35 USC § 119(e) of U.S. Provisional Patent Application No. 62/644,879 filed Mar. 19, 2018, the contents of which are incorporated herein by reference.

### BACKGROUND

In the field of bed coverings, heated blankets have a plurality of electric heating elements incorporated therein; the heating elements may comprise lengths of a heating wire run back and forth along the length or width of the blanket. The lengths of heating wire may be placed within a channel or channels in order to restrain the positions thereof.

Traditionally, the lengths of heating wire may be secured and incorporated within a heated blanket by one of two methods. In the first method, a “carriage” layer may be made with the necessary channel(s) formed from two layers of inexpensive, basic fabric secured to one another by stitching. The lengths of heating wire may be inserted into the carriage layer. Layers of outer fabric may then be placed in front of and behind the carriage to form the inner and outer surfaces of the heated blanket. The four layers of fabric may then be tacked together to complete the heated blanket. In the second method, channel(s) for the lengths of heating wire may be formed from blanket fabric, with no separate carriage layer being employed. The two layers of blanket fabric may be quilted together to form the necessary channel(s), and the lengths of heating wire may be inserted or otherwise secured therein.

Certain aspects of this disclosure provide a three-layered heated blanket that may be simpler and more economical in construction than prior four-layered heated blankets. Certain aspects of this disclosure also relate to a three-layered heated blanket that may provide better concealment of one or more of the wire, heating elements, or wire channel(s), as seen on the outer surface of the heated blanket, than prior two-layered heated blankets.

### BRIEF SUMMARY OF THE INVENTION

Briefly stated, in certain embodiments of the invention, a heated blanket comprises a base fabric layer; an inner fabric layer quilted to the base fabric layer in a manner forming a wire channel between the base fabric layer and the inner fabric layer; a heating wire disposed within the wire channel; and a face fabric layer secured to one or more of the base fabric layer or the inner fabric layer.

Briefly stated, certain embodiments of a method according to the invention comprise quilting an inner fabric layer to a base fabric layer in a manner forming a wire channel between the base fabric layer and the inner fabric layer; and threading a heating wire through the wire channel.

### BRIEF DESCRIPTION OF THE SEVERAL VIEWS OF THE DRAWINGS

The foregoing summary, as well as the following detailed description of certain aspects of this disclosure, will be better understood when read in conjunction with the appended drawings. For the purpose of illustrating the invention, there is shown in the drawings an example device according to the present disclosure. It should be understood, however, that the claimed invention is not limited to the precise arrangements and instrumentalities shown. In the drawings:

FIG. 1 is a top front exploded perspective view of an example of a heated blanket;

FIG. 2 is a top view of the heated blanket of FIG. 1;

FIG. 2A is a magnified partial top view of the heated blanket of FIG. 1;

FIG. 3 is a bottom view of the heated blanket of FIG. 1;

FIG. 3A is a magnified partial bottom view of the heated blanket of FIG. 1;

FIG. 4 is a top view of an example of a heated blanket, with one corner folded over to show the base fabric layer thereof;

FIG. 5 is a top front perspective view of an example of a heated blanket;

and

FIG. 6 is a top front exploded perspective view of the heated blanket of FIG. 5.

### DETAILED DESCRIPTION

Certain terminology is used in the following description for convenience only and is not limiting. The words “lower,” “bottom,” “upper,” and “top” designate directions in the drawings to which reference is made. The words “inwardly,” “outwardly,” “upwardly,” and “downwardly” refer to directions toward and away from, respectively, the geometric center of the heated blanket, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof and words of similar import.

It should also be understood that the terms “about,” “approximately,” “generally,” “substantially,” and like terms, used herein when referring to a dimension or characteristic of a component or other aspect of this disclosure, indicate that the described dimension or characteristic is not a strict boundary or parameter and does not exclude minor variations therefrom that are functionally similar. At a minimum, references that include a numerical parameter include variations that, using mathematical and industrial principles accepted in the art (e.g., rounding, measurement or other systematic errors, manufacturing tolerances, etc.), would not vary the least significant digit.

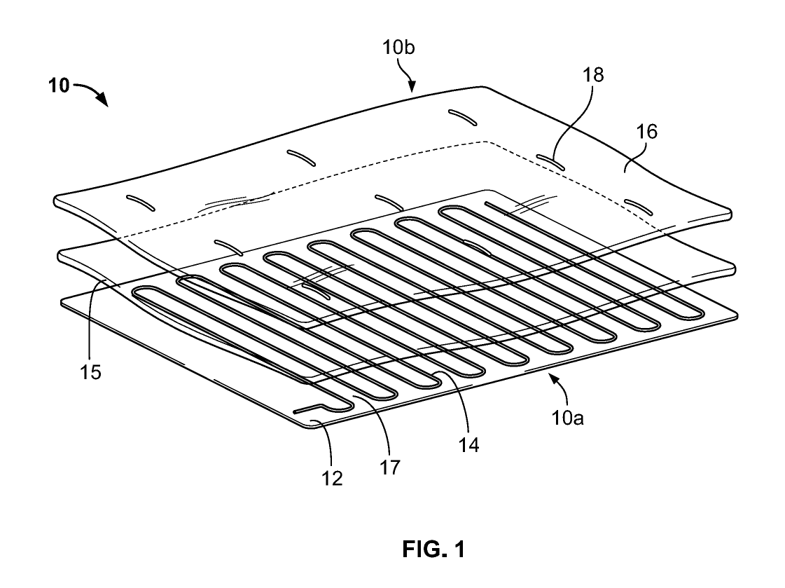

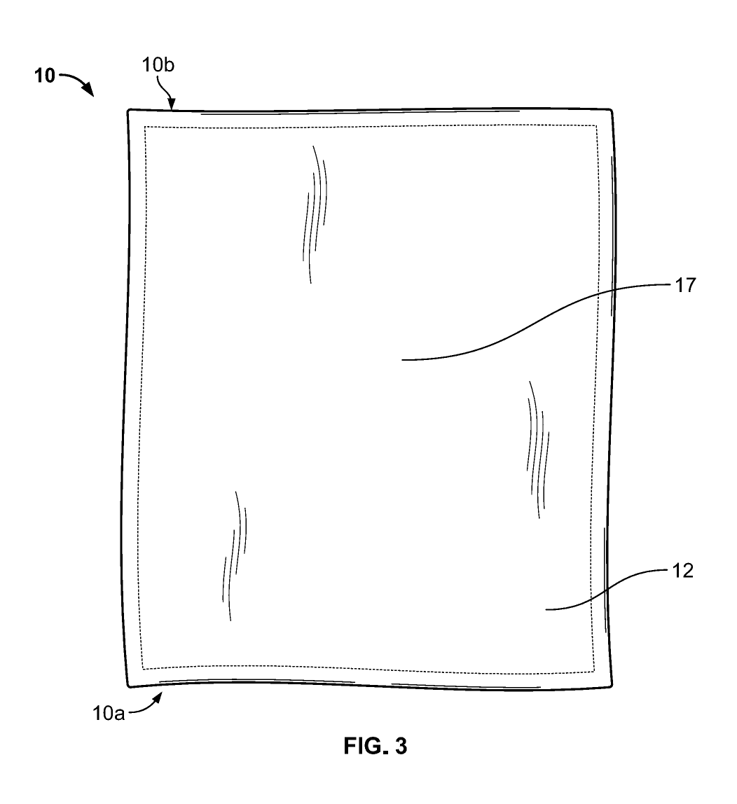

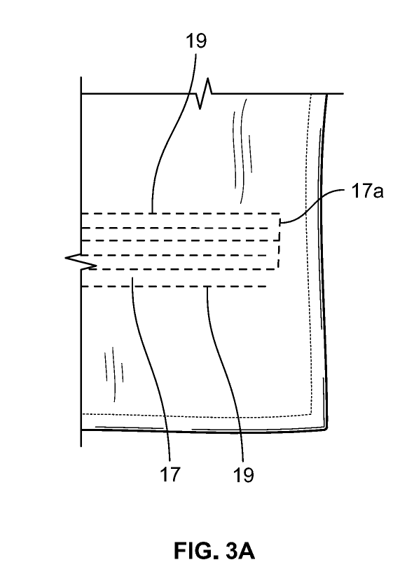

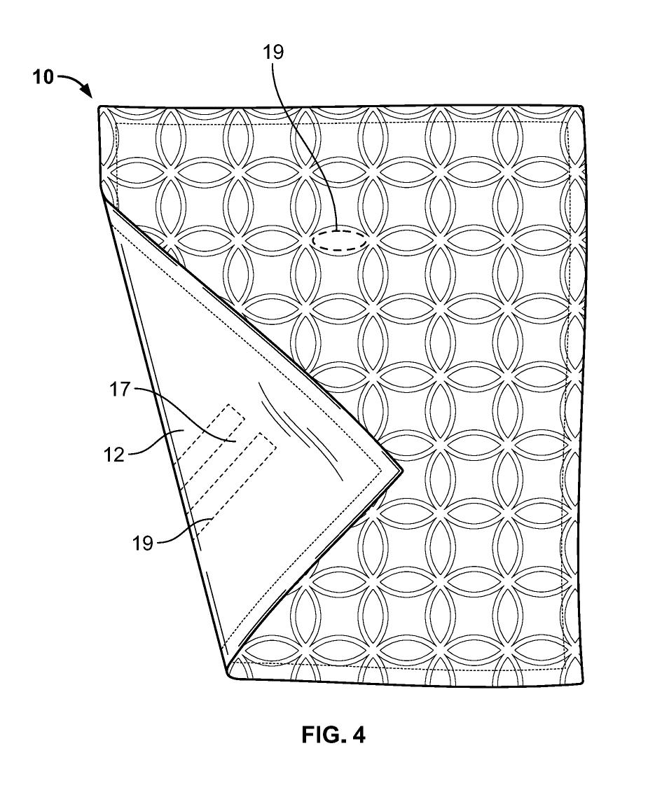

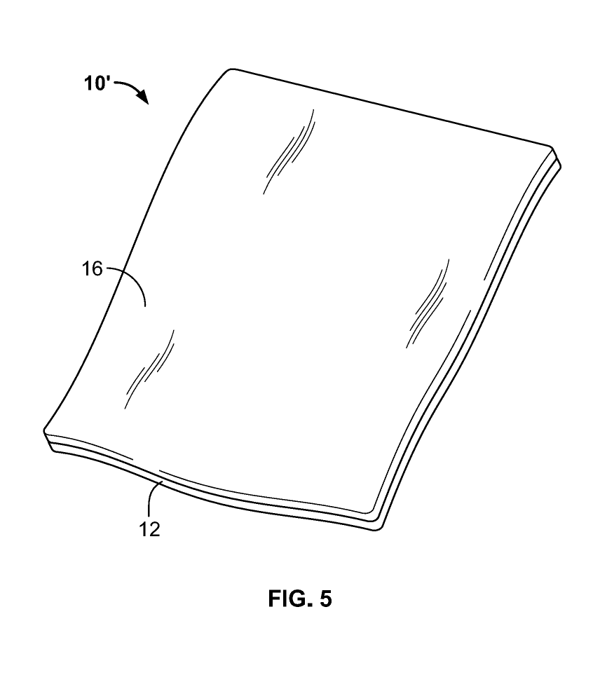

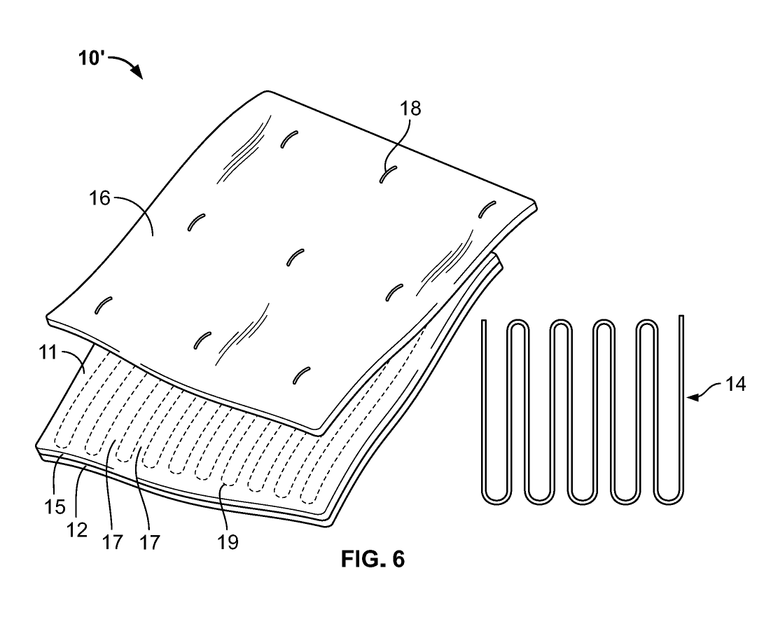

Referring to FIGS. 1-6, examples of heating blankets 10, 10′ are shown. A base fabric layer 12 may be, for example, a comfort layer fabric suitable for the bottom side or inside of a blanket, including but not limited to a polyester plush fabric. An inner fabric layer 15 (visible in FIGS. 5 and 6 only) may be made from a relatively inexpensive non-woven fabric such as, but not limited to, a non-woven polyester. The inner fabric layer 15 may be quilted to the base layer 12 via quilting stitches 19 (FIGS. 3a, 4, and 6) in a manner forming a channel 17 to accommodate lengths of the wire 14. The blanket 10, 10′ may include more than one channel 17. As in the examples shown, a channel 17 may run back and forth over a length or width of the heated blanket 10, with the channel 17 forming a generally U-shaped, roughly 180-degree turn 17a upon reaching a first end 10a of the heated blanket 10 before extending toward a second end 10b of the heated blanket 10. The wire 14 runs through the channel 17 back and forth between the first end 10a and the second end 10b, with the turn 17a at each end of the wire providing spacing (see FIG. 1) of each length of the wire 14 from the adjacent lengths of wire 14, and with the channel 17 securing the lengths of wire 14 in that position.

One example of a method of manufacturing a heated blanket 10, 10′ comprises providing a base fabric layer 12 and an inner fabric layer 15; quilting the inner fabric layer 15 to the base fabric layer 12 in a manner forming a wire channel 17 between the base fabric layer 12 and the inner fabric layer 15; and threading a heating wire 14 through the wire channel 17 and leaving the heating wire 14 extending through the wire channel 17. Certain embodiments of the method include providing a face fabric layer 16 and securing the face fabric layer 16 to one or more of the base fabric layer 12 or the inner fabric layer 15 to form a three-layered structure comprising the base fabric layer 12, the inner fabric layer 15, and the face fabric layer 16 for the heated blanket 10, 10′.

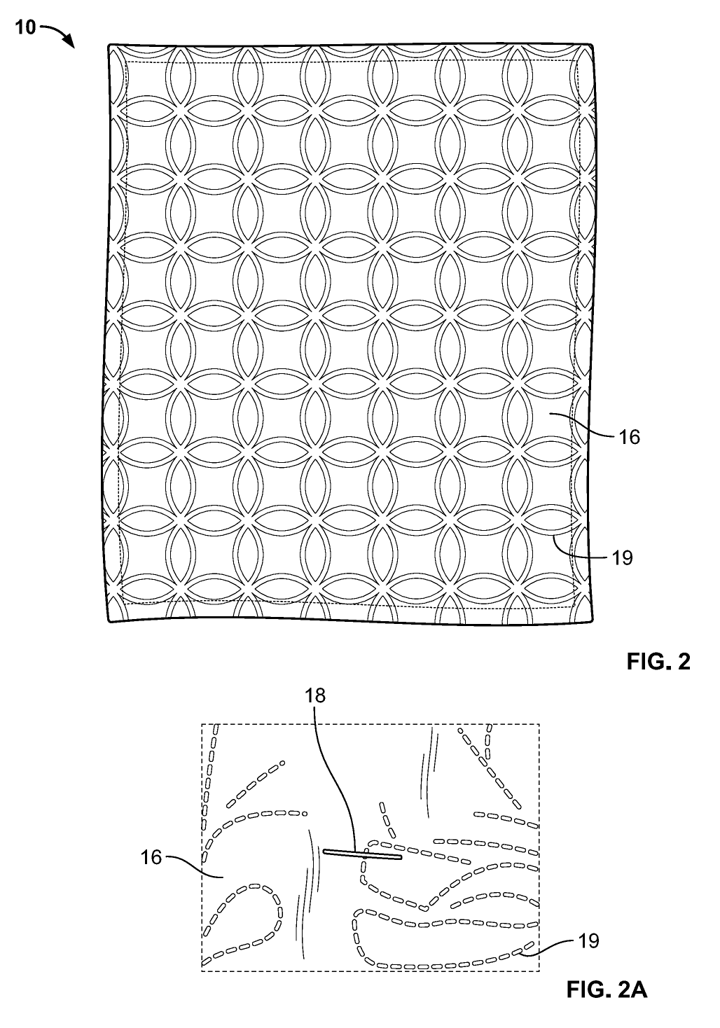

A face fabric layer 16 may be made from an exterior-surface fabric, which may be a fabric suitable for the outer surface of the blanket, for example, a decorative fabric. The face fabric layer 16 may be secured to one or more of the base fabric layer 12 and the inner fabric layer 15 by, for example, several tacking stitches 18 (sets of three are shown) running in the same direction as the lengths of heating wire 14. The tacking stitches 18 may be applied using a “jump and tack” process. The face fabric layer 16 may, but need not, be of a quilted construction and may optionally include quilting stitches 19 on a surface thereof, as best seen in FIGS. 2, 2A, 3A and 4. The base fabric layer 12 may be provided with a mirror edge finish 20 (FIGS. 3, 4, and 6), which may be employed to attach the perimeter of the face fabric layer 16 to the perimeter of the base fabric layer 12. Other known attachments, such as self-hemming, may be used. Where the blanket 10, 10′ is rectangular, the lengths of heating wire 14 may be oriented along either a longer side (FIGS. 5 and 6) or a shorter side (FIGS. 1 through 4) of the blanket 10, 10′, as desired.

It will be appreciated by those skilled in the art that changes could be made to the embodiments described above without departing from the broad inventive concept thereof. It is understood, therefore, that the scope of the invention is not limited to the particular embodiment disclosed, but it is intended to cover modifications within the spirit and scope of the present disclosure as defined by the appended claims.

I/We claim:

1. A heated blanket comprising:
a base fabric layer;
an inner fabric layer quilted to the base fabric layer in a manner forming a wire channel between the base fabric layer and the inner fabric layer;
a heating wire disposed within the wire channel; and
a face fabric layer secured to one or more of the base fabric layer or the inner fabric layer.

2. The heated blanket of claim 1, wherein the inner fabric layer is formed from a non-woven fabric.

3. The heated blanket of claim 1, wherein the inner fabric layer is formed from a non-woven poly fabric.

4. The heated blanket of claim 1, wherein the base fabric layer is formed from a plush blanket fabric.

5. The heated blanket of claim 3, wherein the base fabric layer is formed from a plush blanket fabric.

6. The heated blanket of claim 4, wherein the base fabric layer is formed from a polyester plush fabric.

7. The heated blanket of claim 5, wherein the face fabric layer is formed from an exterior-surface fabric.

8. The heated blanket of claim 1, wherein the face fabric layer is secured to one or more of the base fabric layer or the inner fabric layer by a tacking stitch.

9. The heated blanket of claim 2, wherein the face fabric layer is secured to one or more of the base fabric layer or the inner fabric layer by a tacking stitch.

10. The heated blanket of claim 4, wherein the face fabric layer is secured to one or more of the base fabric layer or the inner fabric layer by a tacking stitch.

11. The heated blanket of claim 8, wherein the face fabric layer is secured to one or more of the base fabric layer or the inner fabric layer by a tacking stitch.

12. The heated blanket of claim 1, wherein the base fabric layer has a mirror edge finish attaching the face fabric layer to the perimeter of the base fabric layer.

13. The heated blanket of claim 1, wherein the face fabric layer is secured to one or more of the base fabric layer or the inner fabric layer by three sets of tacking stitches running parallel to the heating wire and applied by jumping and tacking.

14. The heated blanket of claim 2, wherein the face fabric layer is secured to one or more of the base fabric layer or the inner fabric layer by three sets of tacking stitches running parallel to the heating wire and applied by jumping and tacking.

15. The heated blanket of claim 3, wherein the face fabric layer is secured to one or more of the base fabric layer or the inner fabric layer by three sets of tacking stitches running parallel to the heating wire and applied by jumping and tacking.

16. A method of manufacturing a heated blanket, the method comprising:
quilting an inner fabric layer to a base fabric layer in a manner forming a wire channel between the base fabric layer and the inner fabric layer; and
threading a heating wire through the wire channel.

17. The method of manufacturing a heated blanket of claim 16, further comprising:
securing a face fabric layer to one or more of the base fabric layer or the inner fabric layer to form a three-layered structure comprising the base fabric layer, the inner fabric layer, and the face fabric layer.
